(19) United States
(12) Patent Application Publication
(10) Pub. No.: US 2006/0136242 A1
(43) Pub. Date: Jun. 22, 2006

(54) Documents between services exchange and visualization of negotiation

(75) Inventor: Brian D. Goodman, New York, NY (US)

Correspondence Address: John E. Campbell;IBM Corporation Intellectual Property Law, 2455 South Road - P386, Poughkeepie, NY, 12601, US

(73) Assignee: International Business Machines Corporation, Armonk, NY (US)

(21) Appl. No.: 11/018,898

(22) Filed: Dec. 21, 2004

(51) Int. Cl. G06Q 99/00

(52) U.S. Cl. 705/1

(57) ABSTRACT

A system, method and program product usable in a computer network in which a first service on a first node is seeking connection to a second service on a second node. A system is provided for the exchange and visualization of negotiation documents between the services when one of the services requires an agreement with the other service before the connection is completed. The first service on the first node in the network provides a service offering document, and the second service on the second node provides a statement of work document responsive to the service offering document received from said first service. A visualization of the statement of work document is displayed by the first service such that a user may accept the terms in the statement of work document. If the user accepts the statement of work, an agreement document is sent from the second service to the first service.

### FIELD OF THE INVENTION

This invention relates to the visualization and autonomic negotiation in a networked environment, and more particularly to visualization and autonomic negotiation for offering, provisioning and contracting services in a networked environment.

### BACKGROUND OF THE INVENTION

U.S. Pat. No. 6,553,347 B1 issued Apr. 22, 2003 to Tavor et al. for AUTOMATIC VIRTUAL NEGOTIATIONS, discloses a method for conducting one-to-one and automatic virtual negotiations with the system adjusting the negotiation process more specifically for a user.

U.S. Patent Application Publication US 2002/0032765 A1 published Mar. 14, 2002 by Pezzutti for INTELLIGENT NETWORK PROVIDING NETWORK ACCESS SERVICES (INP-NAS) discloses an intelligent network providing network access services, service activation and provisioning within a self-healing network of services. The system automatically detects at the site of a network accessing system in accessing an event by a user or an installer.

U.S. Patent Application Publication US 2002/0046157 A1 published Apr. 18, 2002 by Solomon for SYSTEM, METHOD AND APPARATUS FOR DEMAND-INITIATED INTELLIGENT NEGOTIATION AGENTS IN A DISTRIBUTED NETWORK and US Patent Application US 2002/0069134 A1 published Jun. 6, 2002 by Solomon for SYSTEM, METHOD AND APPARATUS FOR AGGREGATION OF COOPERATIVE INTELLIGENT AGENTS FOR PROCUREMENT IN A DISTRIBUTED NETWORK disclose system and method for aggregation of cooperative intelligent agents for procurement in a distributed network with automated negotiation and procurement of products, services and bundles.

Japanese Patent JP9036955A published Feb. 7, 1997 by Takahide et al. for INFORMATION COMMUNICATION SERVICE DISTRIBUTION AND COOPERATION CONTROL, METHOD AND CONTROLLER THEREFORE for discloses an information communication service in which a service request form a customer is received and conditions of the present customer is acquired from an information acquisition. A negotiation acquires information from the information acquisition and a plan is generated suited to the conditions of the present user based on the plan received from the caller side according to the rules in a negotiation formation knowledge storage.

Japanese Patent JP2002366788A published Dec. 20, 2002 by Naosuke for MEDIATION SYSTEM discloses mediation system to automatically search for an item close to the desire of the customer and includes an agent function which includes negotiation condition data. The negotiation function performs autonomous negotiation processing based on the data.

Papaioannou et al., EFFICIENT AGENT-BASED SELECTION OF DIFFSERV SLAs OVER MPLs NETWORKS WITHIN THE ASP SERVICE MODEL, Journal of Network and Systems Management, vol. 10, no. 1 pp. 6390 (March 2002) (INSPEC 7275970) discloses autonomic negotiation using various types of documents which are conditional relative to the specific service being rendered.

Chang et al., A NEGOTIATION ARCHITECTURE FOR FLUID DOCUMENTS, UIST '98 San Francisco, Calif., ACM 0-58113-034-1/98/11 pp. 123-132 (1998) discloses negotiation architecture for fluid documents for ensuring that presentations by both primary and supporting material are honored and fluid user interfaces are implemented.

Bond et al., AN OPEN ARCHITECTURE FOR NEXT-GENERATION TELECOMMUNICATION SERVICES, ACM Transactions on Internet Technology, Vol. 4, No. 1, pp 83-123 (February 2004) discloses an open architecture for IP telecommunications based on a comprehensive strategy for managing feature interaction.

The prior art does not provide for the visualization and autonomic negotiation for offering, provisioning and contracting services in a networked environment as set forth in the present invention.

### SUMMARY OF THE INVENTION

The shortcomings of the prior art are overcome and additional advantages are provided through common negotiation document definitions and dynamic graphical user interfaces. The present invention provides the capability to visualize service offerings specified by common markup. Moreover, the visualization is enabled within the interaction context of service flow building applications described in U.S. Patent Application Serial No. 10/406378 filed Apr. 2, 2003 by Goodman et al. for PROGRAM CREATION BY COMBINING WEB SERVICES USING GRAPHIC USER INTERFACE CONTROLS (attorney docket number POU920020082US1); U.S. patent application Ser. No. 10/679759 filed Oct. 6, 2003 by Goodman et al. for CREATING WEB SERVICES PROGRAMS FROM OTHER WEB SERVICES PROGRAMS (attorney docket no. POU920030105US1) and U.S. Pat. No. 6,094,655 issued Jul. 25, 2000 to Rogers et al. for METHOD OF CREATING AND USING NOTES DECISION CAPSULES, all assigned to the assignee of the present invention and incorporated herein by reference. This invention achieves such capability through the definition of common negotiation documents.

The present invention is a system enabling the secure exchange, visualization and selection of service offerings in a service-building environment resulting in a document of work.

One object of the present invention is to provide a secure method of exchanging service-offering documents. In an embodiment of the present invention, a service-offering document resides on a first node of a network. A second node identifies a service of interest based on a user interaction or as part of a cataloging routine. As part of this identification, the second node requests the service interface definition (such as Web Services Description Language, WSDL). As part of the service description, a unique network identifier points to the service-offering document. Alternatively, the contents of the service-offering document is included as part of the service interface definition. The second node requests the service-offering document from the first node. In another embodiment, a first node of a network requests the service-offering document of a second node. The first node requests authenticity validation of the second node's service-offering document from a third node. The third node validates the authenticity of the document and the first node trusts the document. In one embodiment, the third node acts as an intermediary enabling the transaction to be trusted by the first and second nodes.

Another object of the present invention is to provide the visualization of the service-offering document. In an embodiment of the present invention, a second node of a network retrieves a service-offering document from a first node. The service-offering document is interpreted and displayed as part of the graphical user interface and experience for the user. In another embodiment of the present invention, the presentation is a result of joining a first service to a second service or modifying the connection of a first service to a second service.

Another object of the present invention is to provide for interaction with the service-offering document. A pre-defined endpoint is part of the service-offering document wherein a node of a network submits a request for a contract. In one embodiment, a first user selects an option of service based on the display of the service-offering document. The user identifies that the selection is complete by interacting with the graphical user interface. A message may be sent to the specified endpoint for acceptance of a contract. In another embodiment, a first node of a network looks to global environment settings to make the decision to automatically accept a contract.

It is a further object of the present invention to provide a statement of work as an official document which is generated based on the contract of services. The statement of work is a record of the agreement based on the service-offering document at the time it is presented. Other data captured in the statement of work might include the submission time of the request for service, the processed time, and any quality of service or properties pertinent to the contract.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a block diagram illustrating a computer network usable with the present invention having a first node running a first service and a second node running a second service, and a third node which is an authentication node;

FIG. 2 is a block diagram of the network of FIG. 1 illustrating the exchange of documents which have been agreed upon by the services of the first and second nodes;

FIG. 3 presents screen captures of a Document of condition Workbench and a Provisioning and contract screen of the system of FIG. 1;

FIG. 4 illustrates the exchanges between first and second nodes of the network of FIG. 1; and

FIG. 5 is a flowchart of the workflow of one embodiment of the negotiation of a contract between the services of the first and second nodes of FIG. 1.

The detailed description explains the preferred embodiments of the invention, together with advantages and features, by way of example with reference to the drawings.

### DETAILED DESCRIPTION OF THE INVENTION

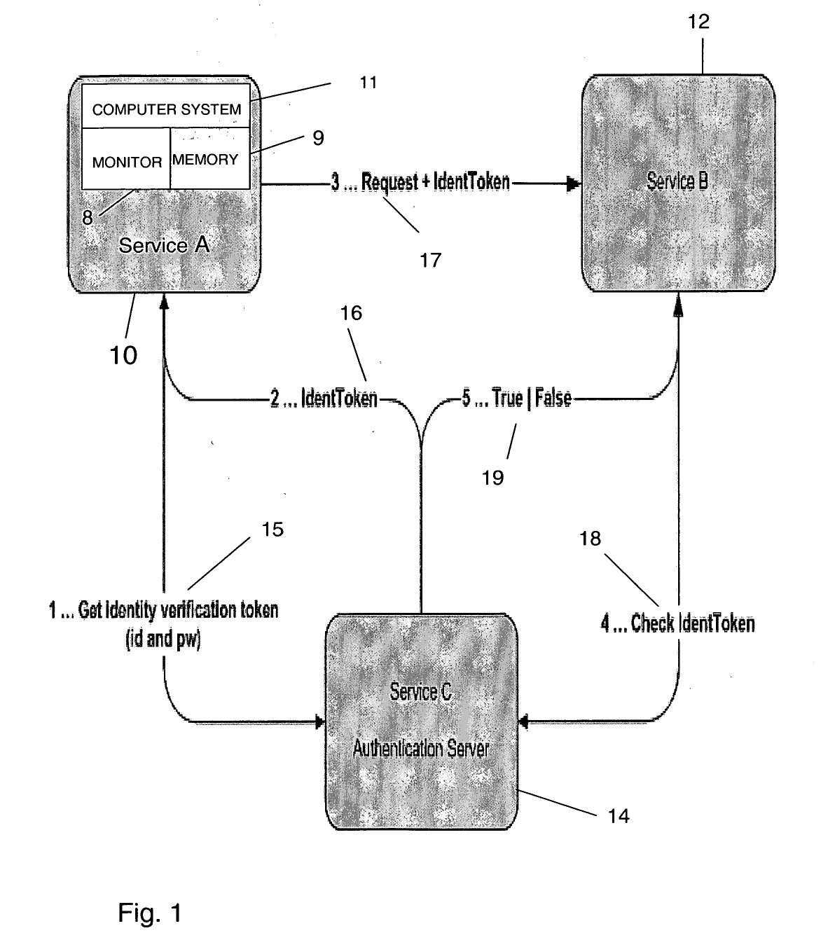

FIG. 1 is a block diagram illustrating a computer network usable with the present invention having a first node or computer 10 of the network of FIG. 1 running Service A, a second node or computer 12 of the network running Service B, and a third node or computer 14 of the network running Service C which is an Authentication Server. Service C of node 14 is a trusted service of both Service A of node 10 and Service B of node 12. It will be understood that instead of Service C of node 14, a user interaction may be used to provide the authentication function.

Each of the nodes 10, 12 and 14 may include a computer system 11 (shown only in connection with node 10 for simplicity). As well understood, the computer system 11 includes a monitor function 8 and a memory function 9. The memory function 9 may include interior and exterior computer readable media such as computer RAM or ROM memory, hard drive, tape, disk, diskette, compact disk, or other electronic or optical memory media, as is well known. The service, such as Service A of node 10, resides in the memory 9 and is executed by the computer system 11, as is well known.

When Service A wishes to request the exchange of negotiation documents with Service B, Service A gets an identity verification token including an Identification and Password (id and pw) from Service C as shown at 15. Service C at 14 then assigns an id and pw to Service A and sends an Identification Token to Service A as shown at 16. At 17, Service A of 10 sends a request, including the Identification Token to Service B of 12. Service B of 12 then sends a message to Service C of 14 to check the validity of the Identification Token as shown at 18. At 19, a message is sent from Service C of 14 to Service B of 12 indicating if the Identification Token is True of False. In this way, both Service A and Service B can authenticate the other to make sure the request for the exchange of negotiation documents is being sent and received from authorized sites. In this way, when Service C is given an id and password, Service C will return a token. Thus, Service A doesn't have to send the credentials to Service B (which may be on a computer Service does not trust).

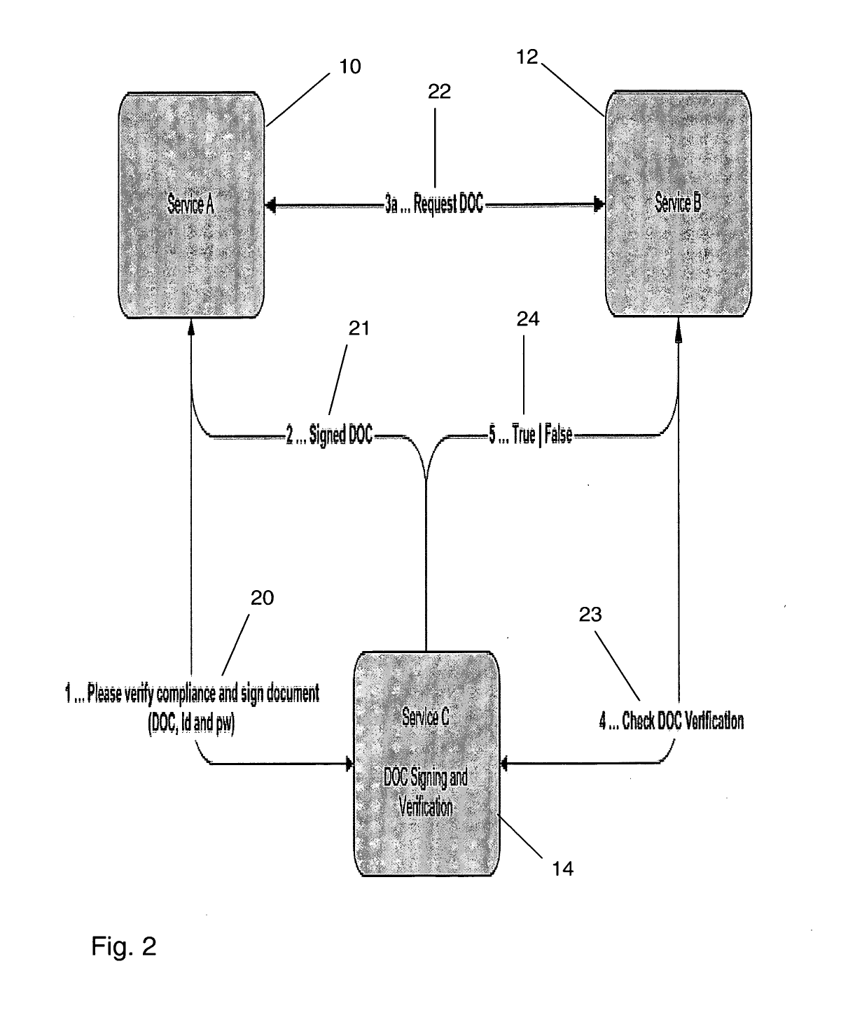

FIG. 2 is a block diagram of the network of FIG. 1 illustrating the exchange of documents which have been agreed upon by Service A and Service B. At 20, Service A of 10 sends a request to Service C of 14 to verify compliance and to sign the document agreed upon. This request includes the document, identification and password (DOC, id and pw) for this exchange. At 21, Service C sends the signed document back to Service A and verifies compliance. At 22, the requested document is exchanged between Service A and Service B. At 23, Service B sends a message to Service C to check the verification of the document. At 24, a True/False response is sent by Service C to Service B to verify the document exchanged.

In another embodiment, the whole document is not required to validate that the document has been signed by the third party (Service C). Only the signature fragment is needed. For example, Service B can calculate by other means known in the art if the document has been tampered with, but the fact that Service C actually signed the document controls. The signature data might include data (often found in signatures) where a one-way hash (checksum) is signed by the third party. This allows Service C to process just that fragment and return a true false in terms of authenticity. It authentic, then Service B deduces that the document is sighed if the checksum contained in the signature matches the checksum run on the document. Checksums can take various forms, but usually are a sequence of characters and numbers that are unique to the specific configuration of bytes. Any changes in the bytes and the data are suspect. Furthermore, if the signature doesn't comply, then Service C didn't sign properly and the fragment is suspect, and thus the document is suspect.

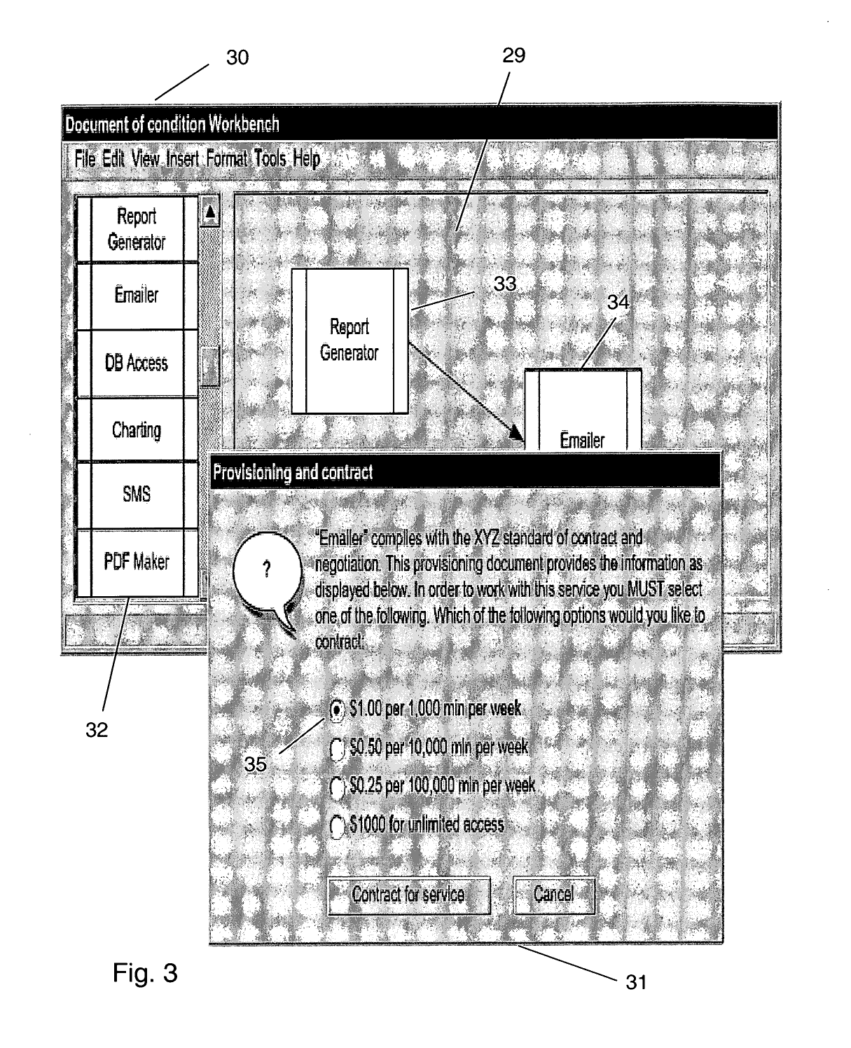

FIG. 3 presents screen captures of the Document of condition Workbench 30 and the Provisioning and contract 31 of the present invention. The Document of condition Workbench 30 includes a menu of web services 32 available to the workbench 30, and includes a real time illustration of the web services as they are being used. For instance, a report generator service 33 is shown connected to an emailer service 34 for transmission of reports from, for example, a first party to a second party. In the Provisioning and contract screen 31, the Emailer web service 34, complies with some contract and negotiation standard of the report generator service 33. This provisioning documents provides the information of the contract being negotiating for. In 31, prices and minimums per week selections are offered. If the second party agrees to accept one of the offered provisions, the second party selects a choice, such as the $1.00 per 1,000 min per week shown at 35. If an acceptable option is selected by the second party, and the “Contract for service” button is selected, the provisioning document is complete, and the final contract documents are exchanged.

As discussed in the aforementioned U.S. patent application Ser. Nos. 10/406378 and 10/679759, a programmer uses a creator program that creates icon support for each web service 32 that will be supported. A menu placer function, places the created icons in the menu 32. Icons are also created for custom programs that are not web services. Such icons can be used to provide audio, visual, mechanical interfaces for instance. Icons are made available to a user either by an authorizing agent or by retrieving icons from a content provider. Preferably, each icon is represented by a title and supporting descriptive text. The title and optionally, the descriptive text as shown in FIG. 3, is displayed at the user's client computer 11 with an associated general icon image. The icon comprises access to program code, web service interfacing controls, as well as visual characteristics.

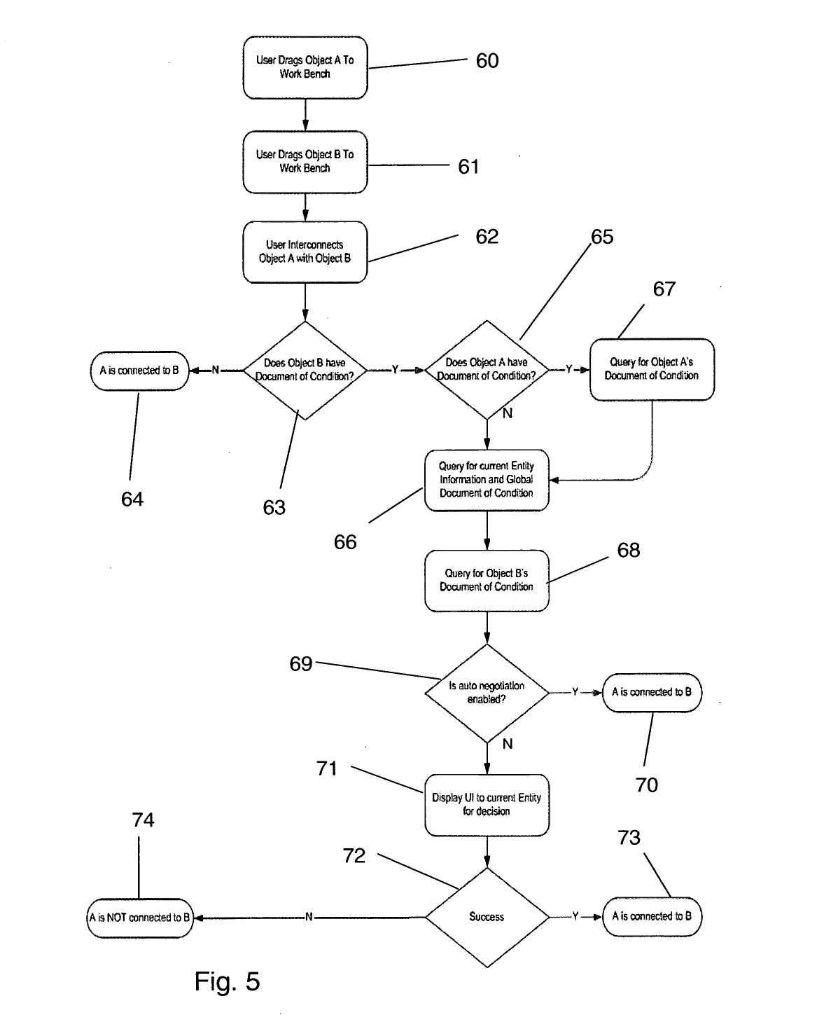

The user selects an icon title and drags it into the canvas 29 of the workbench 30. The user can then execute the icon in the frame to test it's functionality. He can interconnect it with other objects in the frame as discussed in connection with FIG. 5 to create a new functionality. When the icon is dragged into the canvas 29, preferably, a more detailed icon is created that visually depicts interfacing choices (if applicable) such that the user can select the appropriate visual representation when he interconnects the object. The user can set appropriate parameters using a parameter setter Graphical User Interface (GUI) to customize the function of the selected Icon. The user uses a display initiator GUI to display parameter options for an Icon; then, using an operator operating on the display of parameters, the user sets the appropriate parameters; finally, the user exits the display of parameters using an exiting GUI.

As discussed, if a selected web service in the menu 32 requires a contract for use, the Provisioning and contract screen 31 is displayed, and the user may negotiate terms of a contract for use of the selected web service. As mentioned, this negotiation may be conducted, for example, by selecting the desired radio button 35 describing the terms being offered.

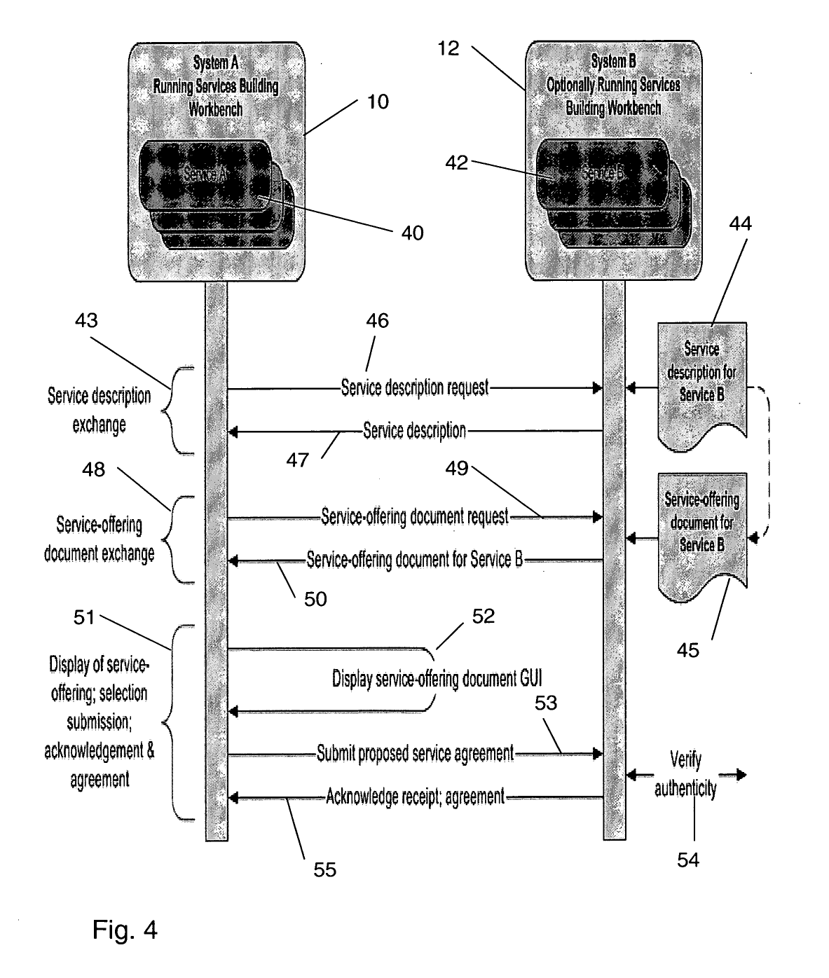

FIG. 4 illustrates the exchanges between systems 10 and 12 of FIG. 1. System 10 includes a service building workbench 40 which is dropped onto a canvas and interconnected with other services. System 12 might run the service building workbench 42, however, this is not required.

The service description exchange is illustrated at 43. At 46, a service description request is made to provide the workbench pallet with the visual representation of the service. The service description of Service B 42 is obtained at 44. At 47, the service description is returned to system 10. System 10 reads the document and identifies the endpoint for the service-offering document.

A first user on system 10 drags the visual representation of service B 42 to the workbench canvas. The user drags a second service to the canvas, and the user interconnects the first service with the second service.

The service-offering document exchange is illustrated at 48. Upon connection, a system 10 identifies a service-offering endpoint exists and requests the document from system 12 at 49. System 12 obtains the service-offering document 45 and responds with the service-offering document 50. It will be understood that in another embodiment, this service-offering document is dynamically generated based on the request at 46 and the requester. System 10 reads the document (Table I).

The service-offering document described in Table I contains two stanzas, header and service-offering. The header stores identifying information such as digital signatures and identity labels such as company and contact information. The header can specify the levels of service provided. For example, 24/7 or no guarantee. The header also includes the servicing endpoint which is the web service that knows how to process requests for service (Table II). The service-offering stanza contains options for service. For example, an options style or radio style, mutually exclusive list.

The display of service offering; selection submission; and acknowledgement and agreement process is illustrated at 5 1. The first system 10 identifies a stanza called service-offering, identifies each tag matching known User Interface (UI) tags to build the Graphical User Interface (GUI) for display to the user (52). This tag matching system is builds the UI. In Table I, the option tag is used to denote a mutually exclusive list of options. This is represented through radio buttons. Only one selection will be accepted, and the basic Accept-and-Cancel buttons will be displayed. Each option describes enough information to represent the selection.

As shown in FIG. 3, the first user is presented with a dialog box. The user selects one of the service offering options, and presses the contract-for-service button.

System 10 identifies the processing endpoint URL and submits the request at 53, Table I is an example of a request for service message. As explained, it has two parts; header and service. Header is reserved for identifying information, signatures, etc. Service identifies the quality of service and the selected service option. The unique ID attribute of the request for service tag lets the transactions between the two servers be uniquely identified.

System 12 receives the request for service 53. System 12 validates with a third system at 54, the authenticity of the document as previously discussed. Upon a positive response from the third system 14, second system 12 decides based on environmental variables, current usage, and the average response time, if the service request is possible. If it is acceptable, a response acknowledging and accepting the request is generated and returned to the first system illustrated at 55 (See Table III).

The third system 14 playing the role of verifying authenticity, might also act as middle man for the first system 10 and the second system 12 as discussed in connection with FIG. 2. The first system 10 requests validation of the original service-offering document (document of condition). This validation at the third system 14 initiates the logging of the end-to-end transaction. A third party signature is returned for the document. The request for service is then submitted with this signature to the second system 12. The second system 12 verifies with the third system 14. The third system 14 validates the documents authenticity. This completes the transaction and optionally provides a document of work (See table IV).

Optionally, each system could leverage Public Key Infrastructure (PKI) as known in the art, wherein every node has a certificate (public key) and every node has a private key. The private key is used to decrypt, while the public key is distributed so that other nodes can encrypt to the node containing the private key. This infrastructure assists in the validation and security of the system. For example, instead of the third party offering signing services, Service C provides public key lookups. Service A asks for Service B's public key. Optionally, Service A would store the key in a local store so as to eliminate future requests to Service C for transactions pertaining to using Service B's public key. Service B decrypts the message knowing it could have only come from Service A, especially as it was signed with Service A's key. Signing requires the private key; validating signatures only requires the public key. Service B then requests Service A's public key from Service C, and optionally stores it for future use to encrypt, sign and respond to the message. Nodes for Service A and B keep Service C's certificate (public key) to validate.

In another embodiment, the third system 14 might be the clearing house (logging billing, etc.). In still another embodiment, the second system is responsible for billing the first system 10. In yet another embodiment, the first system 10 is issued a special key, login, password, or certificate to access the second system 12. In yet another embodiment, the response for service might be for the use of a fourth system pointed to by the third system 14 as potentially having a more suitable environment. The more suitable environment might be, for example, based on location, load, etc.

Table I is a sample listing of a service-offering document as follows:

```
TABLE I
<?xml version=“1.0” encoding=“iso-8859-1”?>
<document-of-condition>
  <header>
    <identity company=“” contact=“” signature=“”/>
    <process endpoint=“https://clearinghouse.com/webservices/service”/>
    <standards-compliance name=“”/>
    <qos uptime=“24/7” avgResponseTime=“350”/>
  </header>
  <service-offering>
    <options>
      <option id=“” cost=“$0.25” duration=“100” description=“$0.25
per 100 transactions”/>
      <option id=“” cost=“$0.50” duration=“1000” description=“$0.50
per 1,000 transactions”/>
      <option id=“” cost=“$10.00” duration=“2500”
description=“$10.00 per 2,500 transactions”/>
      <option id=“” cost=“$100.00” duration=“10000”
description=“$100.00 per 10,000 transactions”/>
      <option id=“” cost=“$1000.00” duration=“−1” description=“$1000
for unlimited transactions”/>
    </options>
  </service-offering>
</document-of-condition>
```

Table II is a sample listing of a request for service document as follows:

TABLE II

```
<?xml version=“1.0” encoding=“iso-8859-1”?>
<request-for-service uid=”4AAFfa32454ddgs4547”>
    <header>
        <identity company=“” contact=“” signature=“”/>
  </header>
    <service>
        <selected-qos uptime=“24/7” avgResponseTime=“350”/>
        <selected-option id=“” cost=“$0.50” duration=“1000”
description=“$0.50 per 1,000 transactions”/>
    </service>
</request-for-service>
```

Table III is a sample listing of a response from a request for service as follows:

TABLE III

```
<request-for-service-response>
    <header>
      <identity company=“” contact=“” signature=“”/>
    </header>
    <service-accepted>
      <selected-qos uptime=“24/7” avgResponseTime=“350”/>
      <selected-option id=“” cost=“$0.50” duration=“1000”
description=“$0.50 per 1,000 transactions”/>
      <service-provider-identity company=“” contact=“”
      signature=“” endpoint=“”/>
    </service-accepted>
</request-for-service-response>
```

Table IV is a sample listing of a document of work as follows:

TABLE IV

```
<document-of-work>
    <parties>
      <provider>
          <identity company=“” contact=“” signature=“”/>
      </provider>
      <customer>
          <identity company=“” contact=“” signature=“”/>
      </customer>
    </parties>
    <service>
      <selected-qos uptime=“24/7” avgResponseTime=“350”/>
      <selected-option id=“” cost=“$0.50” duration=“1000”
description=“$0.50 per 1,000 transactions”/>
    </service>
</document-of-work>
```

FIG. 5 is a flowchart of the workflow of one embodiment of the negotiation wherein there is a successful contract if A is connected to B. At 60, a user drags Object A to the workbench. At 61, the user drags Object B to the work bench. At 62, the user interconnects Object A with Object B for sending requests and responses back and forth. A check is made at 63 to determine if Object B has a Document of Condition. If the check at 63 is no, A is connected to B. If the check at 63 is yes, a check is made at 65 to determine if Object A has a Document of Condition. If the check is 65 is yes, a query is made at 67 for Objects A's document of Condition.

If the check is 65 is no, or when Object A's Document of Condition, at 66 a query is made for the current Entity information and the Global Document of Condition. At 68, a query is made for Object B's Document of Condition. At 69, a check is made to determine if auto negotiation is enabled. If the check at 69 is yes, A is connected to B at 70. If the check at 69 is no, at 71 the UI is displayed to the current Entity for a decision. A check is made at 72 to determine if the decision requested at 71 resulted in success. If yes, A is connected to B at 73. If no, A is not connected to B at 74.

It will be understood that, even though the documents are shown in the present examples as existing on the same system, the documents could reside anywhere such as in the internet wherein a URI/URL points to the document/s or document generators. Also, in the present examples services A and B negotiate on behalf of themselves. It will be understood that a third party, such as node 14, may provide a service of creating and distributing the documents on behalf of services A and B.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. In a computer network wherein a first service is seeking connection to a second service, a system for the exchange and visualization of negotiation documents between the services when one of the services requires an agreement with the other service before the connection is completed, said apparatus comprising:
a first node in said network having the first service for providing a service offering document;
a second node in said network having the second service for providing a statement of work document responsive to said service offering document received from said first service;
a display in said first service, whereupon said first service displays said statement of work document from said second service for visualization of said statement of work;
an acceptance routine in said first service enabling a user to accept terms in said statement of work document; and
an agreement generating routine in said second service for completing an agreement document upon acceptance by said user of said statement of work document.

2. The computer network according to claim 1 further comprising a third node in said network for authenticating service offering documents and statement of work documents sent between said first and second nodes.

3. The computer network according to claim 2 wherein said authenticating comprises verification of said first node's documents locally at said first node by a public key from said third node.

4. The computer network according to claim 1 wherein said statement of work includes options which may be selected by said user to accept said statement of work.

5. The computer network according to claim 3 wherein said options comprise a list of mutually exclusive options.

6. The computer network according to claim 5 wherein said mutually exclusive options are delimited by radio buttons, one of which may be selected by said user.

7. A system for negotiating for the use of a web service comprising:
a menu of web services for use in the creation of a program;
a workbench onto which web services in said menu may be dragged during the creation of said program;
a connecting routine for connecting web services dragged to said workbench; and
a negotiation process in said connecting routine for negotiating for the use of at least one of the web services on said workbench before said connection is completed.

8. The system of claim 7 further comprising a network having a first and a second node wherein said workbench is on said first node, and the provider of one of said web services is on said second node, and said negotiation process includes;
sending a service offering document from said first node to said second node, responsive to said service offering document, sending a statement of work document from said second node to said first node,
visualizing said statement of work document at said first node such that a user may accept said statement of work document, and
responsive to said user accepting said statement of work document, sending a service agreement from said first node to said second node indicating said negotiation process is successful.

9. The system of claim 8 further comprising a third node in said network for verification of said service offering document sent between said first and second nodes.

10. The system of claim 9 wherein said statement of work document includes options selectable by said user for acceptance by said user of said statement of work document.

11. A method of negotiating for a web service, the method comprising the steps of:
sending from a first node in a network, a service offering document;
responsive to the sending of said service offering document, receiving from said second node, a statement of work document;
negotiating by user input at said first node, acceptance of said statement of work document; and
upon negotiating acceptance of said statement of work document, receiving at said first node from said second note, an agreement document containing the results of said negotiating step.

12. The method of claim 11 wherein said statement or work includes options to be selected by the user, and said negotiating step comprises the user selecting one of said options from said statement of work.

13. In a computer network wherein a first service is seeking connection to a second service, a method for the exchange and visualization of negotiation documents between the services when one of the services requires an agreement with the other service before the connection is completed, said method comprising:
providing a service offering document from the first node to the second node;
responsive to said service offering document received from said first service, providing a statement of work document from the second node to the first node;
displaying at said first node, a visualization of said statement of work;
enabling a user to accept terms in said statement of work document; and
generating in said second service an agreement document upon acceptance by said user of said statement of work document.

14. The method according to claim 13 further comprising authenticating at a third node, service offering documents and statement of work documents sent between said first and second nodes.

15. The method according to claim 13 further comprising including in said statement of work, options which may be selected by said user to accept said statement of work.

16. The method according to claim 15 wherein said options comprise a list of mutually exclusive options.

17. The method according to claim 16 further comprising delimiting by radio buttons, said mutually exclusive options, one of which may be selected by said user.

18. A method for negotiating for the use of a web service comprising:
providing a menu of web services for use in the creation of a program;
dragging onto a workbench, web services in said menu may during the creation of said program;
connecting web services dragged to said workbench;
negotiating for the use of at least one of the web services on said workbench; and
connecting web services dragged to said workbench upon successful negotiation.

19. The method of claim 18 wherein a network has a first and a second node, said workbench is on said first node, and the provider of one of said web services is on said second node, and said negotiating includes;
sending a service offering document from said first node to said second node, responsive to said service offering document, sending a statement of work document from said second node to said first node,
visualizing said statement of work document at said first node such that a user may accept said statement of work document, and
responsive to said user accepting said statement of work document, sending a service agreement from said first node to said second node indicating said negotiation process is successful.

20. The method of claim 19 further comprising verifying at a third node in the network, said service offering document sent between said first and second nodes.

21. The method of claim 20 wherein said verifying comprises:
communicating with said third node, said communicating including exchanging a public key for signature verification and encryption; and
using locally at said first and second nodes, said public key for signature verification and encryption of said documents exchanged between said first and second nodes without further communication with said third node.

22. The method of claim 20 further comprising selecting by said user, options in said statement of work document for accepting said statement of work document.

23. A program product usable with a system for negotiating for a web service, said program product comprising:
a computer readable medium having recorded thereon computer readable program code performing the method comprising:
sending from a first node in a network, a service offering document;
responsive to the sending of said service offering document, receiving from said second node, a statement of work document;
negotiating by user input at said first node, acceptance of said statement of work document; and
upon negotiating acceptance of said statement of work document, receiving at said first node from said second note, an agreement document containing the results of said negotiating step.

24. The program product of claim 23 wherein said statement or work includes options to be selected by the user, and said negotiating step comprises the user selecting one of said options from said statement of work.

25. A program product usable in a computer network wherein a first service is seeking to connect to a second service, said program product comprising:
a computer readable medium having recorded thereon computer readable program code performing a method for the exchange and visualization of negotiation documents between the services when one of the services requires an agreement with the other service before the connection is completed, said method comprising:
providing a service offering document from the first node to the second node;
responsive to said service offering document received from said first service, providing a statement of work document from the second node to the first node;
displaying at said first node, a visualization of said statement of work;
enabling a user to accept terms in said statement of work document; and
generating in said second service an agreement document upon acceptance by said user of said statement of work document.

26. The program product according to claim 25 wherein said method further comprises authenticating at a third node, service offering documents and statement of work documents sent between said first and second nodes.

27. The program product according to claim 25 wherein said method further comprises including in said statement of work, options which may be selected by said user to accept said statement of work.

28. The program product according to claim 27 wherein said options comprise a list of mutually exclusive options.

29. The program product according to claim 28 wherein said method further comprises delimiting by radio buttons, said mutually exclusive options, one of which may be selected by said user.

30. A program product for negotiating for the use of a web service comprising:
a computer readable medium having recorded thereon computer readable program code performing the method comprising:
providing a menu of web services for use in the creation of a program;
dragging onto a workbench, web services in said menu may during the creation of said program;
connecting web services dragged to said workbench;
negotiating for the use of at least one of the web services on said workbench; and
connecting web services dragged to said workbench upon successful negotiation.

31. The program product of claim 30 usable with a network having a first and a second node, said workbench is on said first node, and the provider of one of said web services is on said second node, and said negotiating of said method includes;
sending a service offering document from said first node to said second node, responsive to said service offering document, sending a statement of work document from said second node to said first node,
visualizing said statement of work document at said first node such that a user may accept said statement of work document, and
responsive to said user accepting said statement of work document, sending a service agreement from said first node to said second node indicating said negotiation process is successful.

32. The program product of claim 31 wherein said method further comprises verifying at a third node in the network, said service offering document sent between said first and second nodes.

33. The program product of claim 32 wherein said method further comprises selecting by said user, options in said statement of work document for accepting said statement of work document.
